(19) United States
(12) Patent Application Publication
(10) Pub. No.: US 2013/0226975 A1
(43) Pub. Date: Aug. 29, 2013

(54) METHOD FOR FILE MANAGEMENT AND MOBILE DEVICE USING THE SAME

(71) Applicant: Pantech Co., Ltd., (US)

(72) Inventor: Hwan Hee LEE, Seoul (KR)

(73) Assignee: Pantech Co., Ltd., Seoul (KR)

(21) Appl. No.: 13/705,876

(22) Filed: Dec. 5, 2012

(30) Foreign Application Priority Data
Feb. 29, 2012 (KR) 10-2012-0021500

(51) Int. Cl. G06F 17/30

(52) U.S. Cl. CPC G06F 17/3007
USPC 707/821

(57) ABSTRACT

A mobile device includes an information obtaining unit to access a content file to be selected by a user among content files stored in a plurality of categories having different access steps to obtain information on the content file; and a file manager including a container manager to generate a virtual container by using the information obtained through the information obtaining unit, and to store the information on the content file to provide it to a user or an application program.

### CROSS-REFERENCE TO RELATED APPLICATION

This application claims priority from and the benefit under 35 U.S.C. §119(a) of a Korean Patent Application No. 10-2012-0021500, filed on Feb. 29, 2012, which is incorporated herein by reference for all purposes.

### BACKGROUND

1. Field of the Invention

Embodiments relate to a method for managing files and a mobile device using same.

2. Discussion of the Background

A mobile device may refer to a handheld, portable, or tablet computer device configured to perform one or more of video calls, voice calls, internet browsing and searches, and e-reading, and the mobile device may be capable of executing a variety of application programs. The mobile device may have a liquid crystal display (“LCD”) screen or may have an e-ink screen. A user may install application programs, which may be referred to as “apps”, on the mobile device for execution.

The application program (or app) is a program developed for resolving a specific task or performing a specific operation, and may process data such as characters, images, sound, and/or video. In an operating system of a mobile device, there is no system for separately managing content files stored in a mobile device, unlike in Personal Computers (PCs). Accordingly, in order to manage content files, an additional application program may be downloaded and executed to manage content resources having a common Multipurpose Internet Main Extension (MIME) type. A file management application program may be downloaded from a web to manage files, which are structured in an internal/external file system.

However, if files are managed in the above manner, a linkage application program is executed with a mutual calling convention for data sharing during file attachment or transmission in order to configure its own list. Additionally, since file selection is only possible in the same category in a categorized folder structure, there are limitations in selecting various content files with uncommon MIME types.

While Windows or Linux of a general PC may allow a user to browse files for each category with a storage folder or a display method of a virtual folder concept, this is only a file displaying method, and provides only a reconfiguration method by filtering categories and metadata.

### SUMMARY

Exemplary embodiments of the present invention provide a method for file management and a mobile device using same.

Additional features of the invention will be set forth in the description which follows, and in part will be apparent from the description, or may be learned by practice of the invention.

Exemplary embodiments of the present invention provide a method for managing files in a mobile terminal, including executing a container configuration mode, receiving a container selection of a target container to be associated with a first content file and a second content file, retrieving information corresponding to the first content file and information corresponding to the second content file, and storing the information corresponding to the first content file and the information corresponding to the second content file in a content file list corresponding to the target container.

Exemplary embodiments of the present invention provide a method for managing a file list in a mobile device, including calling a container configuration mode, displaying a container view comprising a plurality of containers, receiving a selection corresponding to a first content file, and sharing information corresponding to the first content file with an application program. Each container among the plurality of containers corresponds to a plurality of Uniform Resource Identifiers (URI) respectively corresponding to a plurality of content files.

Exemplary embodiments of the present invention provide a mobile device having a processor, a memory to store a database, and an operating system having a file management system, the file management system including an information obtaining unit configured to obtain information corresponding to a first content file and a second content file, the first content file and the second content file having different categories, and a container manager configured to generate a virtual container comprising the information corresponding to the first content file and the second content file, and to share the information with an application program. A container controller is configured to store a plurality of Uniform Resource Identifiers (URI) respectively corresponding to a plurality of content files, the plurality of content files including the first content file and the second content file.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a mobile device having a file manager according to an exemplary embodiment of the present invention.

FIG. 2 is a block diagram of an Android operating system in a mobile device according to an exemplary embodiment of the present invention.

FIG. 3 illustrates an access method between a file manager and an application program according to an exemplary embodiment of the present invention.

FIG. 4 illustrates a container list and a content file list according to an exemplary embodiment of the present invention.

FIG. 5 illustrates a file manager configuration and FIG. 6 illustrates a method for generating a content file list in a file manager according to an exemplary embodiment of the present invention.

FIG. 7 illustrates a file manager configuration, and FIG. 8 illustrates a method for sharing a container and a content file with an application program in a file manager according to an exemplary embodiment of the present invention.

FIG. 9(a) and FIG. 9(b) illustrate a method for storing a selected content file in a virtual container according to an exemplary embodiment of the present invention.

FIG. 10(a), FIG. 10(b), and FIG. 10(c) illustrate a method for attaching content files in a virtual container into an e-mail message according to an exemplary embodiment of the present invention.

FIG. 11(a), FIG. 11(b), and FIG. 11(c) illustrate a method for linking content files in a virtual container into a multi-media message service (MMS) message according to an exemplary embodiment of the present invention.

FIG. 12(a) and FIG. 12(b) illustrate a method for generating a live folder on a home screen according to an exemplary embodiment of the present invention.

FIG. 13(a) and FIG. 13(b) illustrate a method for linking an application program with a live folder displayed on a screen according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

Hereinafter, a mobile device and a method for managing files in a mobile device will be described in more detail with reference to the drawings.

FIG. 1 is a block diagram of a mobile device having a file manager according to an exemplary embodiment of the present invention.

Referring to FIG. 1, a mobile device includes a hardware layer, a platform to process and deliver a signal input from the hardware layer, and an application program layer. Application programs operating on the platform run on the application program layer. The platform may be an Android platform, a Windows mobile platform, or an iOS platform, for example, according to an operating system of a mobile device. Each type of platform may have a different structure, but a platform may have the same basic role regardless of platform type. The platform may include a software block.

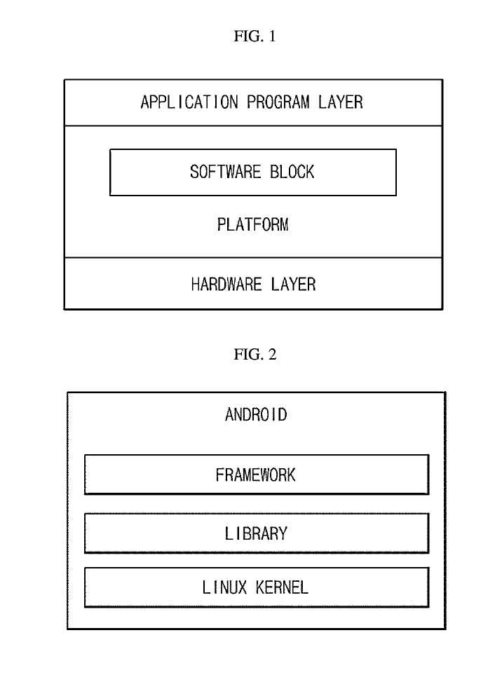

FIG. 2 is a block diagram of an Android operating system in a mobile device according to an exemplary embodiment of the present invention.

Referring to FIG. 2, an Android platform includes a Linux kernel layer to manage a variety of hardware, to deliver a request of an application program to a hardware, and to deliver a reply of the hardware to the application program, a library layer to connect the hardware with a framework layer, the library layer being programmed using C or C++, and the framework layer to manage a variety of application programs.

Although not shown, the Windows mobile platform includes a Windows core layer corresponding to the Linux kernel layer, and an interface layer to connect the Windows core layer with an application program layer and to support various languages and functions.

Although not shown, the iOS platform includes a core OS layer corresponding to the Linux kernel layer, a core services layer corresponding to the library layer and the framework layer, a media layer to provide a multimedia function, and a cocoa touch layer to provide programming frameworks for a variety of application programs.

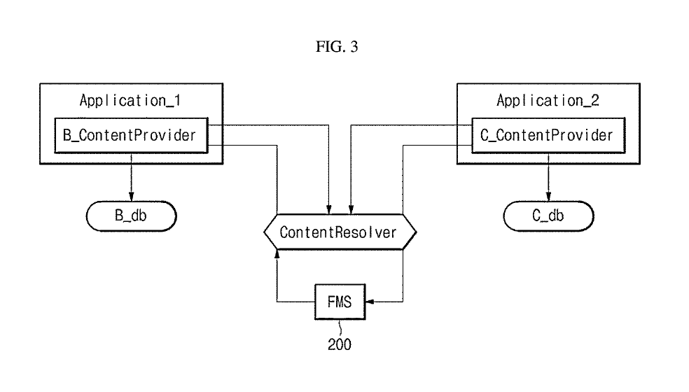

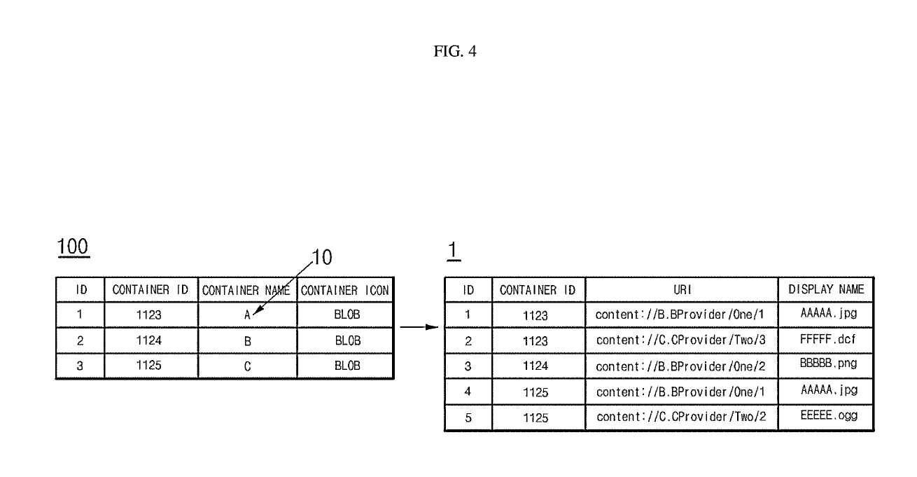

For convenience of description, the following description will be made on the basis of the Android platform with reference to FIG. 2 and FIG. 3. However, the present invention is not limited as such, and may relate to a file management system realized on the iOS or the Windows mobile platform for a mobile device, or another platform having a layer structure consistent with the layer structure shown in FIG. 1.

FIG. 3 illustrates an access method between a file manager and an application program according to an exemplary embodiment of the present invention.

The Android platform of FIG. 2 has a File Management System (FMS) 200, which may operate on a framework layer. Referring to FIG. 3, the FMS 200 may access the databases B_db and C_db, respectively corresponding to application programs Application_1 and Application_2 through content providers B_ContentProvider and C_ContentProvider, also respectively corresponding to application programs Application_1 and Application_2, and a content resolver.

A content provider, as an interface provided from the Android platform, is defined in an application program that provides data, and provides query, insert, delete, and update operations through a method structured in its object.

The content resolver, as an interface for sharing a resource with the FMS 200 and the application programs Application_1 and Application_2, may be defined in the FMS 200, and may receive information (e.g., a resource) in communication with the application programs Application_1 and Application_2 that the content provider defines. In order to access the databases B_db and C_db of the respective application programs Application_1 and Application_2 through the content resolver, a prescribed Uniform Resource Identifier (URI) may be known and used.

The URI as an internet service-based identification system of an information resource unified on internet is used to identify text, video, sound, still, or animation image provided as a service from internet, and its common format is a web page address. The FMS 200 may use an intent instead of the content resolver to share a resource with application programs.

The intent is an interface for taking charge of communication such as a call and a message delivery between application programs in the Android system, and may include action and data. The action relates to how to process a designated data item and the data relates to a target.

If such an intent is used by setting a mutually prescribed action in the intent and calling startActivityForResult, a receiver registered in an application program receives the action, and the application program is executed. Here, startActivityForResult is a command or procedure for executing an application program corresponding to the action.

Once a corresponding resource is selected and finished, resource information may return to the FMS 200 through the intent. At this point, returning the resource information may be accomplished by calling OnActivityResult, and is classified as ResultCode. Additionally, a prescribed action is required for call. Here, OnActivityResult is a command or procedure for receiving data from the application program executed by startActivityForResult, and ResultCode may refer to a specific character string for action return.

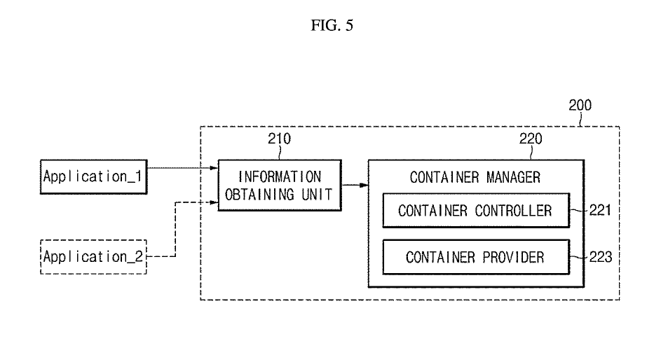

FIG. 4 illustrates a container list and a content file list according to an exemplary embodiment of the present invention. FIG. 5 illustrates a file manager configuration and FIG. 6 illustrates a method for generating a content file list in a file manager according to an exemplary embodiment of the present invention.

First, a configuration of the FMS 200 will be described in more detail with reference to FIG. 5.

Referring to FIG. 5, the FMS 200 manages various content files stored in a memory of a mobile device or in a database of an application program, and includes an information obtaining unit 210 and a container manager 220. Although not shown in the drawing, the FMS 200 may store various kinds of information for managing content files through an additional database that is separate from a database of an application program.

The information obtaining unit 210 obtains URI information of a corresponding content file by accessing a corresponding application program that stores the content file selected by a user. Additionally, the information obtaining unit 210 may obtain information on the ID, name, Multipurpose Internet Main Extension (MIME) type, and icon of a content file, in addition to the URI information of a corresponding content file. The corresponding application program may store a content file such as image, sound, or video in its own database, so that an application program may be selected to provide information to the FMS 200.

For example, the corresponding application program may download a content file such as image, sound, or video, for example via the internet or a local area network, and may store the downloaded file by category. The corresponding application program may include the above-mentioned content provider, shown and described with reference to FIG. 2. Accordingly, the information obtaining unit 210 may receive information of a corresponding content file by accessing a database of a corresponding application program through a content resolver.

Referring back to FIG. 5, the container manager 220 includes a container controller 221 and a container provider 223, and may provide a container configuration mode in which a container may be formed to include one or more selected content files. The container manager 220 may set and provide a menu of the container configuration mode as a main menu of a mobile device system or an additional menu of an application program, or a popup menu when an attachment file of an application program is loaded.

The container controller 221 generates and manages a virtual container, i.e., a kind of a virtual folder, and stores the information obtained through the information obtaining unit 210 in the generated container in order to configure a content file list. That is, the container controller 221 may configure a content file list on the basis of the information on the URI of a corresponding content file and the ID, name, MIME type, and icon of a content file obtained from the information obtaining unit 210.

Referring still to FIG. 4, when a user inputs a command to generate a container 10, the container controller 221 generates an ID and a container ID in an order corresponding to the order that the user generates a container. Additionally, a container name defined by a user or an arbitrary container name is generated, and the icon type used for the generated container is designated, in order to configure a container list 100. The configured container list 100 is stored in a database (not shown) of the FMS 200. Although not shown, the container list 100 may be stored in a database corresponding to an application program.

Additionally, the container controller 221 configures a content file list 1, such as shown in FIG. 4. The content file list 1 includes an ID generated in an order corresponding to the order that a user selects a content file, a container ID identifying the container corresponding to each content file, URI information of a corresponding content file, and a display name that may be displayed to a user.

The container controller 221 may perform editing such as a name change, a configuration change, and deletion with respect to a corresponding item in a container list and a content file list at a user's request.

Based on the above-mentioned description, a method for configuring a container to include a plurality of selected files will be described in more detail.

Information on a content file having at least one category may be stored in one container. For example, after generating a container A, a user may select an image file I1 and a sound file S1 in a first category, a sound file S2 and a video file V1 in a second category, and an image file I2, a sound file S2, and a video file V2 in a third category.

Each time a file is selected, the container controller 221 configures a content file list by storing URI information regarding the selected files, such as in this case the image file I1 and the sound file S1, the sound file S2 and the video file V1, and the image file I2, the sound file S2, and the video file V2. Accordingly, even if different files in different categories having different access steps are selected, file information on various categories may be integrated into one container.

As described above, a container is formed first and then files are selected to be included in the container. However, files may be selected to be included in the container first, and the container may then be formed.

Thus, according to an exemplary embodiment, it is possible for a user to select a plurality of files distributed over different categories through the above-mentioned principle. This differs from the conventional FMS, wherein after selecting contents from a first category and exiting the specific category, a function such as “select” and “copy” of the selected content disappears. Therefore, in order to select a plurality of files in different categories having different access steps using the conventional FMS, after files selected from a first category are copied and transferred, the same operation is required in a second category.

Referring back to FIG. 4, if a user calls the container configuration mode through an application program, or calls an application program after setting the container configuration mode, the container provider 223 provides a container view that displays a stored container in a list or folder type. When a user selects a container from among containers displayed in the container view, a content view is provided to display content files stored in a selected container. The content files may be displayed in a list or icon type. The container stores URI information, not the content file itself, but the display name or URI information may be displayed to a user as if the content file itself is stored in the container.

If a user selects a specific content file stored in a specific container, the container provider 223 may provide the selected content file to a corresponding application program that has already been selected or that is then selected by the user. When a user selects a specific container itself, the container provider 223 may share all files stored in the selected container with a corresponding application program. Here, the corresponding application program may refer to an application program to which a content file is attached, such as a multi-media message service (MMS), a messenger application, or an e-mail message.

For example, if a user tries to attach a plurality of content files to an e-mail after a specific container is selected, all content files stored in the corresponding container are selected. A user may move a container displayed as a folder to an e-mail icon through a drag and drop method, or may load content files of a corresponding container as attachment files by calling a desired container after creating an e-mail.

In this manner, even if text, image, sound, and video files distributed over different categories (i.e., different depths) are selected and transmitted through an application program such as an MMS, a messenger application, or an e-mail program, after each URI information on the files having different categories is stored in a container, multiple files distributed over different categories may be selected by selecting the container.

Accordingly, one virtual container may be used for selecting multiple files even if the files are distributed over several categories to be transmitted or shared through an application program. This may cause the file selection task to become simpler, and file search speed may be increased. Additionally, data transfer speed may be improved because URI information rather than a content file may be transmitted or shared through the application program. Additionally, when data for the same files is repeatedly transmitted, since information is pre-stored in a virtual container to be used more than once, it may be unnecessary to execute the content resolver and the content provider each time information on files is loaded, transmitted, or shared with the application program using a selected container.

Additionally, if a user selects a plurality of content files in a specific container through a container view, the container provider 223 may share only the selected content files with an application program.

For example, when attaching selected content files to a message program, a user selects a specific container in a container view, and then selects a desired content file through a content view provided from the selected container. A user may move one or more selected content files to a message ion through a drag and drop method, or may load them as an attachment file list of a message program by selecting the content files after executing the message program.

As mentioned above, what is shared with or transmitted to an application program after being selected by a user may be a content file itself, or it may be URI information only of a corresponding content file and not the content file itself.

Hereinafter, a method for managing a content file in an FMS will be described in more detail with reference to the drawings. This method for managing a content file in the FMS will be described as if performed by the FMS 200 described above, but is not limited as such.

Referring to FIG. 6, a user executes the FMS 200 in operation S10. In operation S20, a user selects a content file from a category of an application program having a content file that is to be selected or a specific category in a memory of a mobile device.

Then, if a user executes a container configuration mode in operation S30, the container provider 223 provides an application program in execution or a container view on a home screen. The user confirms whether there is a target container into which a content file, which is selected through a container view, is to be stored in operation S40. If there is no target container, the container controller 221 may create a new virtual container in operation S42. A target container is selected in operation S50. The information obtaining unit 210 accesses a database that stores a selected content file to obtain information on the URI, ID, name, MIME type, and icon of a content file, and then stores them in the database of the FMS 200 in operation S60.

On the basis of the information obtained by the information obtaining unit 210, the container controller 221 generates a content file list about the content files that the user has selected in a corresponding container in operation S70.

The generated content file list is provided to a user as a content view such as a list or icon type.

Although it was described that a user selects a content file first, and then executes a container configuration mode, a container configuration mode may be executed first, and a content file may then be selected.

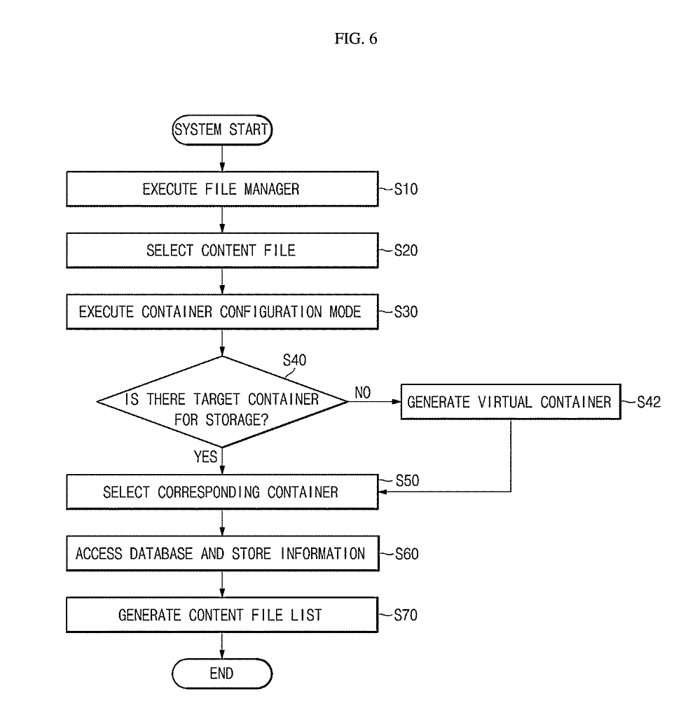

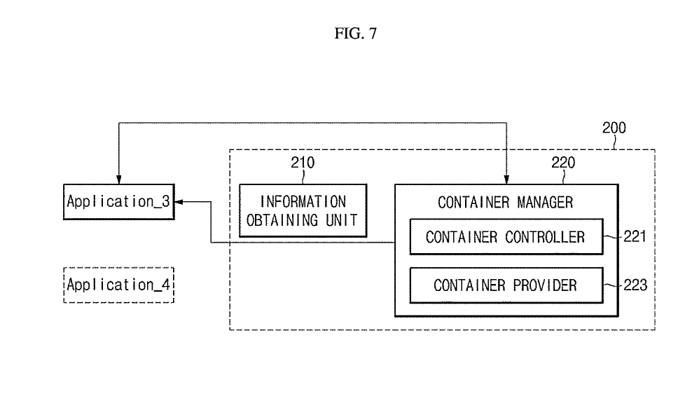

FIG. 7 illustrates a file manager configuration, and FIG. 8 illustrates a method for sharing a container and a content file with an application program in a file manager according to an exemplary embodiment of the present invention.

A method for delivering a content file stored in a container to an application program will be described below in more detail with reference to FIG. 7 and FIG. 8.

If a user executes an application program first and then fetches a content file to be shared with or transmitted to the application program, an application program Application_3 or Application_4 may be executed in operation S100. Here, the application program Application_3 or Application_4 refers to an application program to which a file is attached such as an MMS, a messenger application, or an e-mail program.

After an application program, such as Application_3, is executed, a user may set a container configuration mode in operation S200. The FMS 200 is executed in operation S300. Then, the container provider 223 displays a container view on the application program Application_3 in execution or on a home screen in operation S400, and a user may select a container from among the displayed containers in the displayed container view in operation S500. Alternatively, a user may enter the container to select only a desired content file through the content view in operation S500.

If the user selects a container in operation S500, a plurality of content files stored in the selected container are delivered to the application program Application_3 in operation S600. The application program Application_3 may configure a list of linked files on the basis of information on the received container or content file in operation S700. For example, if Application_3 is an e-mail program, Application_3 may retrieve the content files based on the received information and may attach the content files to an e-mail message. Alternatively, if Application_3 is an e-mail program, Application_3 may retrieve the URIs for the selected content files based on the received information and indicated the selected files as attached to an e-mail message even though only the URIs are actually used by the e-mail program.

Then, the files shared with or attached to the application program Application_3 may be transmitted to another application program or another mobile device. The transmitted information may be the content file(s), such as the image file, sound file, or video file, and the transmitted information may also be the URI information of the corresponding file(s).

Although a user executes an application first, and then selects a container or a content file as described above, a user may select a container or a content file first, and then call an application program.

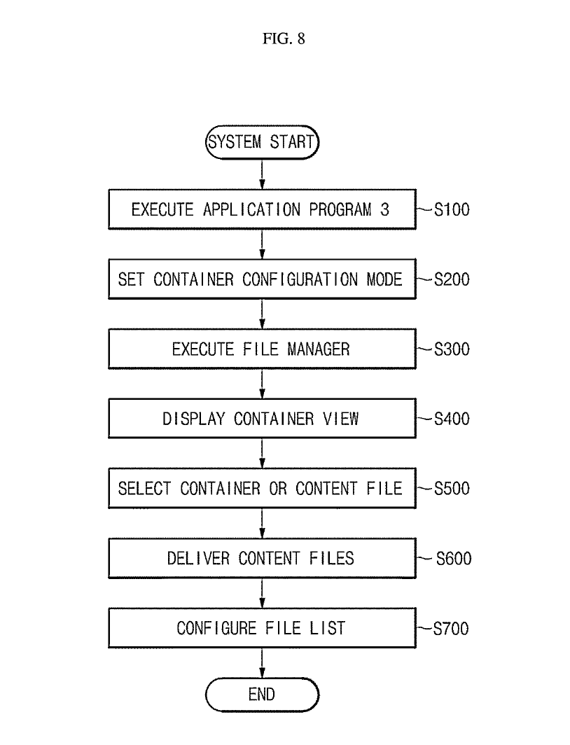

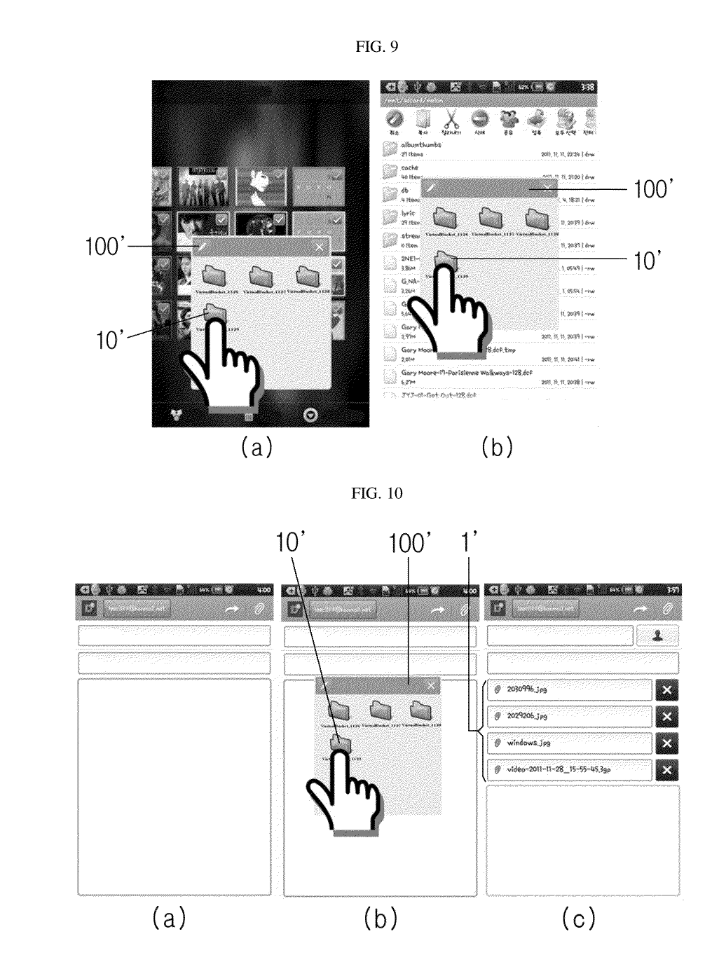

FIG. 9(a) and FIG. 9(b) illustrate a method for storing a selected content file in a virtual container according to an exemplary embodiment of the present invention.

As shown in FIG. 9(a) and FIG. 9(b), a container view 100′ is displayed on an application program in execution, and may include containers 10′ displayed in a folder type.

A user may select files from a content view, which is provided in an image format of FIG. 9(a) or a file format of FIG. 9(b) from an application program, and selects the container 10′ after calling the container view 100′ to store the information of the selected content file in the selected virtual container 10′. The information of contents files having different categories may be stored in one container 10′.

FIG. 10(a), FIG. 10(b), and FIG. 10(c) illustrate a method for attaching content files in a virtual container into an e-mail message according to an exemplary embodiment of the present invention.

An e-mail application program is executed as shown in FIG. 10(a), and a container view 100′ is called as shown in FIG. 10(b). Then, a desired container 10′ may be selected from the container view 100′ as shown in FIG. 10(c). At this point, files 1′ stored in the selected container 10′ may be attached to an e-mail message created by the e-mail application program. The files 1′ stored in the container 10′ may be separately selected and attached. The files 1′ may be retrieved by the e-mail application program and loaded into the e-mail message as attachments, or the e-mail application program may list the display names of the files based on the information shared from the content file list without loading the files into the e-mail application program.

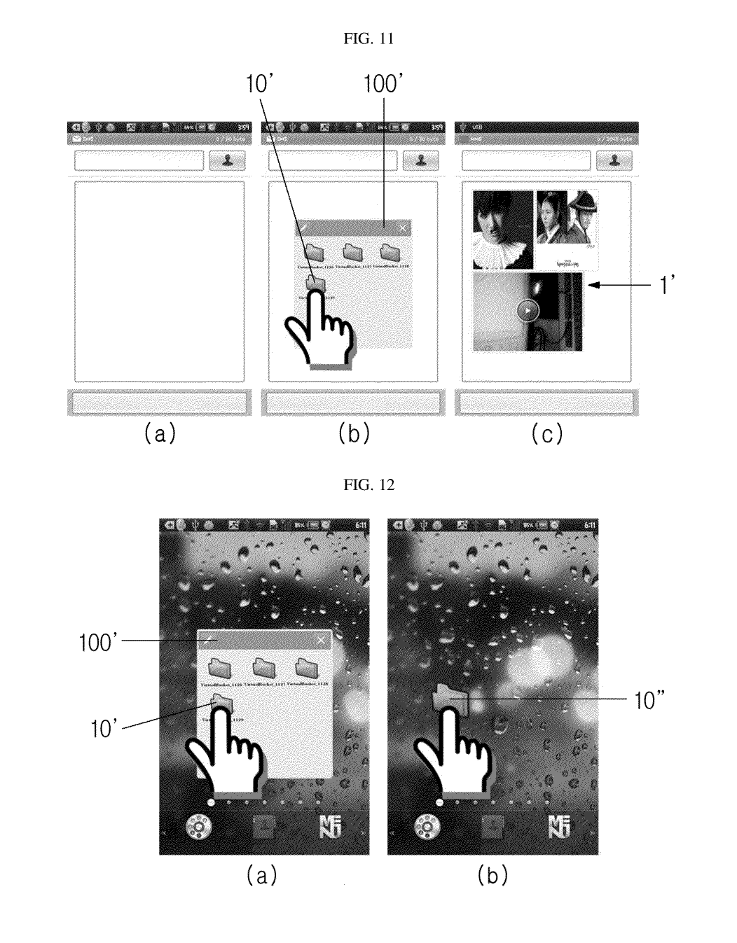

FIG. 11(a), FIG. 11(b), and FIG. 11(c) illustrate a method for linking content files in a virtual container into a multi-media message service (MMS) message according to an exemplary embodiment of the present invention.

An MMS application program is executed as shown in FIG. 11(a), and a container view 100′ is called as shown in FIG. 11(b). Then, a container 10′ may be selected from the containers displayed in the container view 100′. Files 1′ stored in the selected container 221b may be attached to the MMS message. The files 1′ stored in the container 10′ may be separately selected and attached.

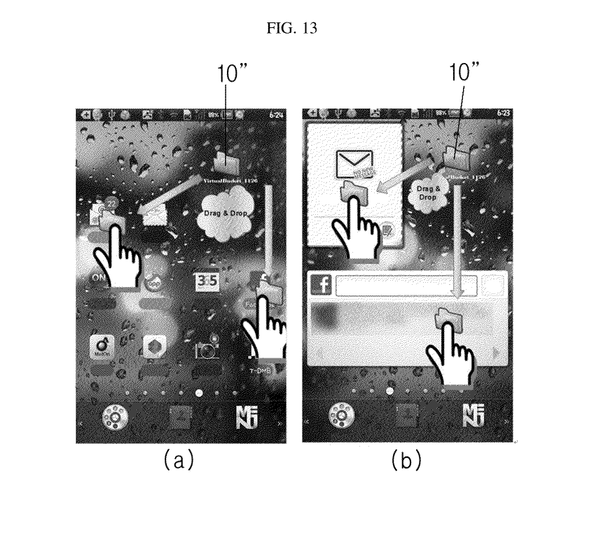

FIG. 12(a) and FIG. 12(b) illustrate a method for generating a live folder on a home screen according to an exemplary embodiment of the present invention. FIG. 13(a) and FIG. 13(b) illustrate a method for linking an application program with a live folder displayed on a screen according to an exemplary embodiment of the present invention.

First, as shown in FIG. 12(a), a file manager is executed to display a container view 100′ on a home screen in a popup type. Then, once a container is selected from the container view 100′, such as through a long key selection method or another comparable input method, as shown in FIG. 12(b), the container 10′ selected from the container view 100′ is generated as a live folder 10″ on the home screen.

Then, through the drag and drop of the live folder 10″, an application program may be selected to be linked the live folder 10″. Here, as shown in FIG. 13(a), an icon corresponding to the application program or an application program widget may be linked to the live folder 10″ by using a drag-and-drop operation of the live folder 10″. Although not shown, the linkage may be achieved by using a drag-and-drop operation of the application program icon or widget.

Conventionally, a plurality of files could not be selected from different folders. Additionally, when a user wanted to share or transmit a plurality of files, a file fetching operation needed to be performed several times, particularly if the files were of different types.

However, according to an exemplary embodiment, content files distributed over a physically-categorized file storage structure are managed using a container, i.e., a virtual integration object, and may be linked with an application program to be manipulated or used by the application program. Therefore, the physically-categorized file storage structure may not need to be modified, and selecting and sharing files in a higher/lower category are possible even if the files are not of the same category. Moreover, a corresponding resource is managed with a URIs of content files.

Additionally, if one content file is loaded during content transmission without accessing a corresponding application program, all files stored in a common container may be transmitted together. As a result, file search and transfer speed may be improved.

According to the above-described exemplary embodiments, a mobile device includes a file manager, which is configured to virtually integrate content files in various categories distributed over several layers, and is configured to manage the integrated multiple files in order to link or share them with an application program.

Additionally, a method for managing files of a mobile device may include virtually integrating files in various categories distributed over several layers, and managing the integrated multiple files in order to link or share them with an application program.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed:

1. A method for managing files in a mobile device, comprising:
executing a container configuration mode;
receiving a container selection of a target container to be associated with a first content file and a second content file;
retrieving information corresponding to the first content file and information corresponding to the second content file; and
storing the information corresponding to the first content file and the information corresponding to the second content file in a content file list corresponding to the target container.

2. The method of claim 1, further comprising:
generating the target container in the container configuration mode.

3. The method of claim 1, wherein the information corresponding to the first content file is retrieved from a database corresponding to an application program.

4. The method of claim 1, wherein the information corresponding to the first content file comprises a Uniform Resource Identifier (URI) of the first content file.

5. The method of claim 1, wherein a container controller configures the content file list comprising a plurality of Uniform Resource Identifiers (URIs) respectively corresponding to a plurality of content files, the plurality of content files including the first content file and the second content file.

6. The method of claim 1, wherein the first content file and the second content file have different Multipurpose Internet Main Extension (MIME) types.

7. The method of claim 1, wherein a container ID, container name, and container icon of the target container are stored in a container list comprising a plurality of containers.

8. The method of claim 1, wherein the content file list comprises Uniform Resource Identifiers (URIs) of a plurality of content files respectively corresponding to a plurality of containers.

9. A method for managing a file list in a mobile device, comprising:
calling a container configuration mode;
displaying a container view comprising a plurality of containers;
receiving a selection corresponding to a first container among the plurality of containers; and
sharing information corresponding to the first container with an application program,
wherein each container among the plurality of containers corresponds to a plurality of Uniform Resource Identifiers (URI) respectively corresponding to a plurality of content files.

10. The method of claim 9, wherein the information corresponding to the first container comprises information corresponding to the plurality of content files corresponding to the first container.

11. The method of claim 10, wherein at least two of the plurality of content files corresponding to the first container have different Multipurpose Internet Main Extension (MIME) types.

12. The method of claim 9, further comprising executing the application program.

13. The method of claim 12, wherein the container configuration mode is called through the application program.

14. The method of claim 12, wherein the application program is called through the container configuration mode.

15. The method of claim 10, wherein sharing information corresponding to the first container with the application program comprises transferring the URIs corresponding to the plurality of content files corresponding to the first container to the application program.

16. The method of claim 15, further comprising storing the URIs corresponding to the plurality of content files corresponding to the first container in a content file list associated with the first container.

17. A mobile device comprising a processor, a memory to store a database, and an operating system comprising a file management system, the file management system comprising:
an information obtaining unit configured to obtain information corresponding to a first content file and a second content file, the first content file and the second content file having different categories; and
a container manager configured to generate a virtual container comprising the information corresponding to the first content file and the second content file, and to share the information with an application program,
wherein a container controller is configured to store a plurality of Uniform Resource Identifiers (URI) respectively corresponding to a plurality of content files, the plurality of content files including the first content file and the second content file.

18. The mobile device of claim 17, wherein the file management system interfaces with a content resolver to retrieve the information corresponding to the first content file from a first application program database.

19. The mobile device of claim 17, wherein the container manager comprises:
a container controller to generate the virtual container and to store the information in a content file list associated with the virtual container; and
a container provider to provide a container view to display the virtual container among a plurality of virtual containers stored in the mobile device, and to share the information with the application program.

20. The mobile device of claim 17, wherein the information comprises an ID, name, Multipurpose Internet Main Extension (MIME) type, icon, and Uniform Resource Identifier (URI) of the first content file.
